(19) United States
(12) Patent Application Publication
(10) Pub. No.: US 2024/0256784 A1
(43) Pub. Date: Aug. 1, 2024

(54) EXTENSIBLE CHATBOT FRAMEWORK

(71) Applicant: MICROSOFT TECHNOLOGY LICENSING, LLC, Redmond, WA (US)

(72) Inventors: Justin Daniel HARRIS, Scarborough (CA); Mahmoud ADADA, Montreal (CA); Dominic MORIN, Saint-Maurice (CA)

(21) Appl. No.: 18/104,251

(22) Filed: Jan. 31, 2023

(51) Int. Cl. G06F 40/35; G06F 40/279; H04L 51/02

(52) U.S. Cl. CPC G06F 40/35; G06F 40/279; H04L 51/02

(57) ABSTRACT

Disclosed is a system for composable chatbot extensions. Chatbot extensions are composed by providing the output of one extension as input to another. This defines a pipeline of extensions that accepts a prompt as input and provides a response as output. Composability makes it easier to leverage functionality provided by other extensions, log output, execute tasks in parallel, and test extensions. In some configurations, each extension declares the inputs it accepts, the outputs it produces, and any modifications it makes to data being passed through the pipeline. An extension may also declare a preferred location in the pipeline, enabling developers to choose whether to respond to a raw prompt as quickly as possible or to wait and receive intermediate results generated by other extensions. At the end of the pipeline a response is provided to the user via the chatbot.

### BACKGROUND

Chatbots are computer programs designed to simulate conversation. A chatbot receives a prompt such as “what time is it?” and replies with a response such as “two PM”. Chatbots can be integrated into various platforms such as websites, messaging apps, and productivity apps. The earliest chatbots were developed in the 1960s and were based on simple rule-based systems. However, with the advancement of Artificial Intelligence (AI) and Natural Language Processing (NLP) techniques, chatbots have become more sophisticated and are able to understand and respond to human input in a more natural way.

Extensions allow developers to augment a chatbot's feature set. For example, a weather extension enables a user to ask whether it will rain. The weather extension may register to be invoked when weather related keywords are detected in a prompt. However, existing chatbot extension architectures are monolithic—a single extension is responsible for providing a response to a prompt. This monolithic architecture is inflexible, difficult to maintain, and difficult to debug.

Chatbots may also be extended via custom integration with other services. However, this entails gaining an understanding of each third-party service. Furthermore, custom code written to integrate with each third-party service is often error prone and difficult to maintain.

It is with respect to these and other considerations that the disclosure made herein is presented.

### SUMMARY

Disclosed is a system for composable chatbot extensions. Chatbot extensions are composed by providing the output of one extension as input to another. This defines a pipeline of extensions that accepts a prompt as input and provides a response as output. Composability makes it easier to leverage functionality provided by other extensions, log output, execute tasks in parallel, and test extensions. In some configurations, each extension declares the inputs it accepts, the outputs it produces, and any modifications it makes to data being passed through the pipeline. An extension may also declare a preferred location in the pipeline, enabling developers to choose whether to respond to a raw prompt as quickly as possible or to wait and receive intermediate results generated by other extensions. At the end of the pipeline a response is provided to the user via the chatbot.

In some configurations the chatbot is itself implemented with composable extensions. This enables third-party extensions that are not part of the chatbot itself to deeply integrate with the chatbot without having to write custom integration code. For example, the chatbot may expose an integration point that invokes a third-party extension as a fallback when the chatbot does not know how to respond to a prompt. Third-party extensions may integrate at any point—from when the prompt first arrives until the response is provided, or any step along the way. For example, an extension that orders pizza could register to be invoked as soon as a prompt is received or wait to see what classifications or other metadata are generated by other extensions.

When a pipeline contains more than one extension, the chatbot attempts to process them in their requested order. At the same time, the chatbot may analyze the declared inputs, outputs, and modifications of each extension and invoke them in an order that satisfies the greatest number of declared inputs. For example, an extension that posts chatbot responses to a social media account may request that the prompt it receives as input has been deemed inoffensive. Another extension may declare that a prompt is inoffensive. The chatbot identifies that the input requirements of the social media extension are satisfied by the offensiveness detecting extension, and so it will invoke the offensiveness detecting extensions first.

In addition to the prompt itself, the chatbot may provide extensions with some or all of a conversation history. The conversation history may include messages that have already been exchanged with the user and pending content responses that have been generated by a chatbot extension but not yet returned to the user. The chatbot may also provide extensions with metadata. Extensions may use metadata and conversation history to improve the quality of the response it generates. For example, the conversation history adds context to the most recent prompt, while metadata indicates what other extensions have determined about the prompt.

Extensions may add a new message to the conversation, modify messages created by another extension but not yet returned to the client, or add to or modify metadata. For example, an extension that helps a user to order pizza may add a new message to the conversation asking the user's favorite toppings. An extension that filters out offensive content may modify an existing message in the conversation to omit an offensive term. An extension that analyzes a response for accuracy may add metadata indicating that a claim made by a previous extension has been verified by an external source.

In some configurations, extensions perform these operations according to a standard defined by the chatbot. Standardization enables extensions from different parties to interoperate with one another. For example, an extension may use standardized key names when inserting key-value pairs in a JavaScript Object Notation (JSON) file that comprises a response. Subsequent extensions in a pipeline of extensions may then reliably retrieve data stored in the standardized way. Different standards are contemplated for different operations that a chatbot extension may perform, such as naming a field in a JSON file that stores an address “Address”.

An extension may also declare the level of granularity at which it receives text generated by a previous extension. The extension may wait for the previous extension in the pipeline to create a complete response before beginning. Or, the extension may elect to receive subsections of the response as they are generated, such as paragraphs, sentences, or tokens. Processing a response as a stream of subsections enables the extension to begin processing significantly sooner than waiting for a complete response. This is particularly useful when the response is produced by a generative language model which may take seconds or even minutes to respond to a single prompt. For example, a speech processing extension that verbalizes a response my elect to receive the output of the previous extension as a stream of sentences or words, enabling the response to be spoken as it is generated.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates a chatbot that is augmented with chatbot extensions.

FIG. 2 illustrates a configuration file of a chatbot extension.

FIG. 3 illustrates a pipeline of chatbot extensions processing a prompt.

FIG. 4 illustrates a request provided to a chatbot extension.

FIG. 5 illustrates a response received from a chatbot extension.

FIG. 6 is a flow diagram of an example method for an extensible chatbot framework.

FIG. 7 is a computer architecture diagram illustrating an illustrative computer hardware and software architecture for a computing system capable of implementing aspects of the techniques and technologies presented herein.

FIG. 8 is a diagram illustrating a distributed computing environment capable of implementing aspects of the techniques and technologies presented herein.

### DETAILED DESCRIPTION

Extensions are first-party or third-party developed applications that can be added to a chatbot to augment its functionality. Previous chatbot extensions were typically invoked with a keyword. For example, if an extension registers to use the keyword ‘weather’, then that extension may be invoked by the prompt “How is the weather today?”. The extension then returns a response to the chatbot to be displayed. These types of extensions lack reusability, increasing their cost. They are also inflexible, and when something goes wrong, more difficult to troubleshoot. In contrast, the disclosed chatbot extensions are composable, allowing extensions to build on the outputs of other extensions.

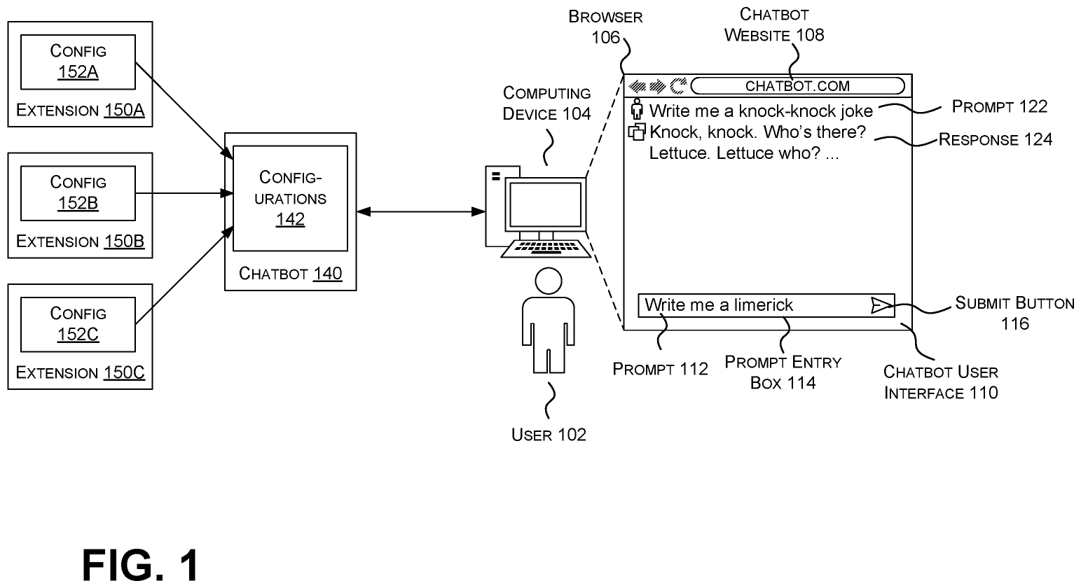

FIG. 1 illustrates a chatbot that is augmented with chatbot extensions. User 102 operating computing device 104 navigates browser 106 to chatbot website 108. Chatbot website 108 is one example of an application that utilizes a generative language model to interact with users in a human-like way. Typically, the chatbot 140 used by chatbot website 108 is located on a remote computing device, although it may also be implemented by computing device 104.

Chatbot user interface 110 includes prompt 112 entered into prompt entry box 114. Clicking or otherwise initiating a trigger associated with submit button 116 will cause prompt 112 to be submitted to chatbot 140. Chat bot user interface 110 shows a history of messages between user 102 and chatbot 140, such as prompt 122 and response 124.

Chatbot 140 contains configurations 142- one or more configurations 152 that have been registered by extensions 150. Extensions 150 extend the capabilities of chatbot 140. As discussed below in more detail, extensions 150 are composable in that the output of one extension may be used as input to another extension. Chatbot extensions are also composable in that they read and write metadata as a request is passed through a pipeline of extensions.

In some configurations, chatbot extensions 150 interact with chatbot 140 without registering configurations 152. In this scenario, one or more chatbot extensions 150 may provide prompts to chatbot 140, similar to how a user would provide chatbot 140 with prompts. The responses provided by chatbot 140 may be further processed by extensions 150 according to configurations 152. These responses may then be provided to other chatbot extensions 150, which may or may not invoke chatbot 140, enabling multiple chatbot extensions 150 to form a chain of extensions. Each extension in the chain of extensions may invoke chatbot 140 before returning a response to a subsequent chatbot extension 150 or the user.

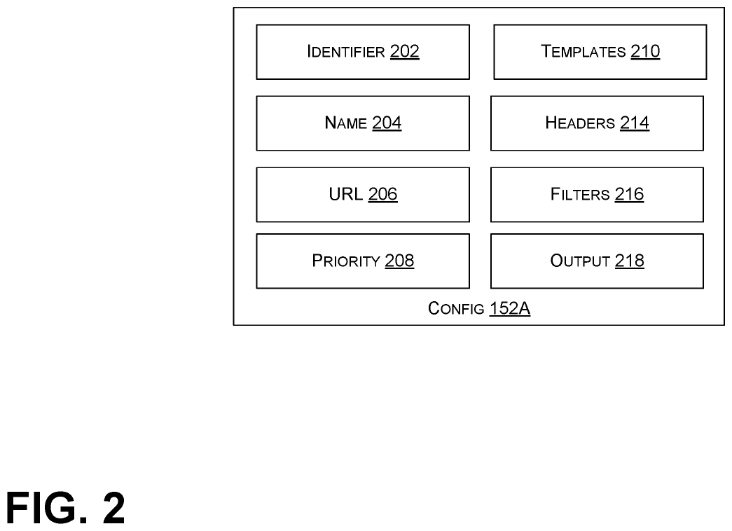

FIG. 2 illustrates a configuration file of a chatbot extension. Configuration file 152A may include one or more of identifier 202, name 204, Uniform Resource Locator (URL) 206, priority ranking 208, templates 210, headers 214, filters 216, and/or output 218. Configuration file 152 may be a JSON file, XML file or any other human readable markup file. Configuration file 152 may also be computer-readable.

Identifier 202 maybe any unique sequence of numbers or letters usable to refer to a particular chatbot extension. Name 204 refers to a descriptive name of the chatbot extension 150A associated with configuration 152.

URL 206 is an HTTP endpoint usable by chatbot 140 to invoke chatbot extension 150A. While web-based chatbot extensions are referred to throughout this document, this is just one example of a technique for referencing a chat bot extension. Other techniques such as referring to a local executable file are similarly contemplated. When chatbot 140 has determined to invoke a particular chat bot extension 150, it may do so by submitting an HTTP request to URL 206. in some configurations, URL 206 also describes an HTTP verb or other connection parameter usable to invoke the target chatbot extension.

When multiple chatbot extensions 150 are registered with chatbot 140, priority 208 is used to determine the order in which they are executed. Priority 208 may be a rank. In some configurations, an extension associated with a lower ranking is executed first. Extensions with the same rank may be executed in parallel.

In some configurations, chatbots adhere to conventions that assign specific priority ranks to specific points in the pipeline of extensions. By adhering to these conventions, extensions may cooperate as to when they will run relative to each other and relative to significant events in the extension pipeline.

For example, a priority of−1 may be assigned to extensions that add to or modify metadata. An extension that responds to a user's message before any other component runs may have a priority of 100. This may include no-code or low-code extensions that ‘hard-code’ particular responses, such as returning a predetermined greeting or returning the IP address of chatbot 140, respectively.

In some configurations, chatbot 140 is itself implemented with composable chatbot extensions. In some configurations, the composable chatbot extensions that implement chatbot 140 are part of the pipeline of extensions. Examples of these built-in extensions include a natural language understanding (NLU) extension, an extension that interfaces with a traditional search engine, an extension that obtains a response from a generative language model, or the like. A priority of 2010 may be associated with extensions that respond to a user's message after rules have been run but before any other main components of the chatbot are run.

A priority of 6100 may provide content based on an NLU classification. An NLU classification may extract intents and entities from the prompt. Generating a response based on NLU classification may be a fallback if chatbot 140 is otherwise unsure how to handle the prompt.

A rank of 8100 may be associated with an extension that ranks responses generated by previously executed extensions and select the best one to use as the response of chatbot 140. A rank of 10100 may add a new message after all components have finished. An extension with a priority rank of 20020 may modify the final response of chatbot 140. An extension with a priority rank of 30010 may augment a response with suggested user responses, or that will auto-complete the user's message. An extension with a rank of 30100 may generate a call-out to get the user's attention. The specific priority ranks listed above are examples, and other values are similarly contemplated. Furthermore, other types of operations are similarly contemplated.

Templates 210 are strings of text interposed with references to data contained in a request. Templates 210 allow responses to be dynamically generated based on the structured data obtained from the context user 102 is operating in and from data generated by previous extensions. Templates 210 are used to implement “low-code” extensions—extensions that do not invoke an HTTP based service, but which compute a response based on the request received and based on templates contained in the configuration file itself. For example, if an extension is provided with a conversation of messages that have already been exchanged between user 102 and chatbot 140, then a template 210 may generate an output based on the text of one or more of the messages in the conversation.

Headers 214 include string key-value pairs that may be referenced by a filter 216, a template 210, or other dynamic aspect of an extension 150.

Filters 216 are conditions that determine whether the corresponding chatbot extension 150 will process a particular request. If no filter 216 is listed, then the corresponding extension 150 will always be invoked. Similar to templates, which generate an output in response to a request, filters may refer to data included in the request. For example, a filter may return ‘true’ if any of the messages in the conversation include the text ‘hey’. If there are multiple filters 216, they may be configured to be satisfied if all of the filters evaluate to true or if at least one of the filters evaluates to true. In some configurations, filters refer to data in the request by a JSON path. Additionally, or alternatively, regular expressions may be used when determining whether the associated extension should be invoked for a particular request.

Filters may be based on the text contained in one or more previous messages of the conversation, the number of previous messages, the content of particular messages (such as the first or last message in a conversation). Filters may also refer to a content origin property. For example, an extension may selectively be run when a content origin of a message in the conversation is a particular search engine. Filters may also be based on metadata generated by previous extensions, such as NLU classifications, whether or not a prompt or previous response was offensive, or the like.

Output 218 indicates the outputs of no-code and low-code extensions. As referred to above, a no-code extension returns a hard-coded value, such as a string literal. A low-code extension uses a template to dynamically generate a response based on string literals in the template, template operators such as string concatenation, and reference to data submitted in the request being processed.

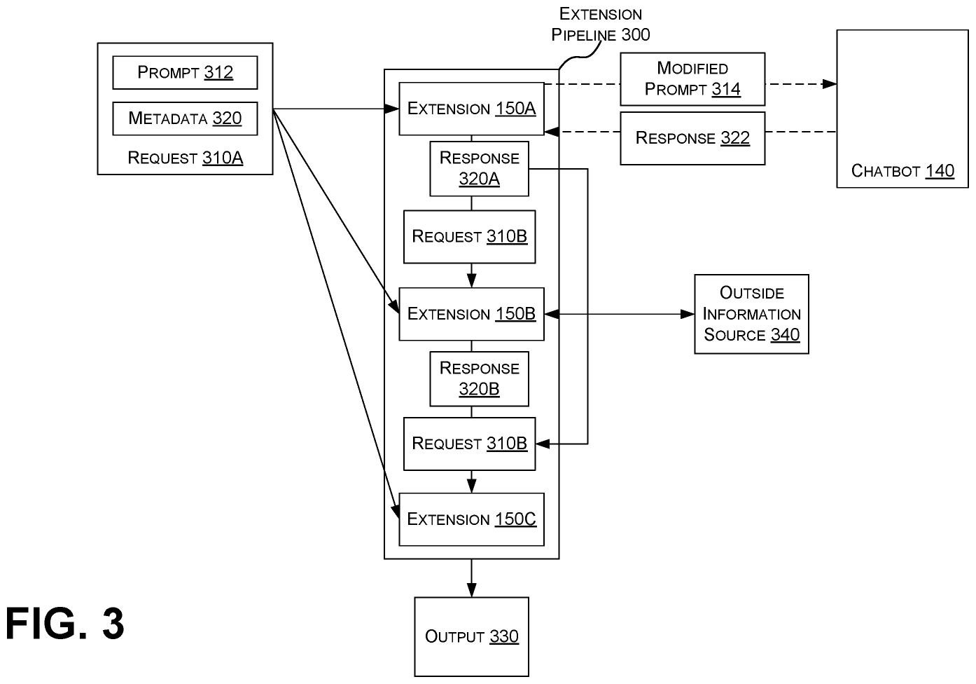

FIG. 3 illustrates a pipeline 300 of chatbot extensions 150 processing a prompt 312 of a request 310A. As illustrated, pipeline 300 includes extension 150A, extension 150B, and extension 150C. These extensions may be ordered based on their relative priority values 208. As each extension is executed, responses 320 are received and incorporated into subsequent requests 310. For example, response 320A generated by extension 150A may include a message generated by extension 150A. This message may be added to a conversation that is included in request 310B. The message may be added according to standard defined by chatbot 140. In this way, extension 150B is able to access the outputs of extension 150A. Extension 150B generates response 320B, which is added to request 310B for submission to extension 150C. Request 310B also includes response 320A and the contents of request 310A, enabling extension 150C access to all of the data generated by extensions 150A and 150B.

Generative language models come across as confident and decisive, but they are not always completely accurate. One use-case of composable chatbot extensions is to double-check factual claims made by a generative language model. Extension 150B illustrates making a connection to an outside information source 340, such as a search engine, an online dictionary, or the like. Extension 150B may use this information to verify the content of response 320A.

Extension pipeline 300 emits output 330, which may include one or more messages.

These messages may be returned to browser 106 for display to user 102.

In some configurations, chatbot extensions 150 leverage a chatbot 140 without registering to be invoked. For example, extension 150A receives request 310A which includes prompt 312. Extension 150A may modify prompt 314 before forwarding it to chatbot 140. For example, extension 150A may sanitize prompt 312, removing offensive language. Extension 150A may then receive response 322 from chatbot 140. Response 322 may then be modified before providing response 320A to chatbot extension 150B. Extension 150B may also invoke chatbot 140 while responding to request 310A.

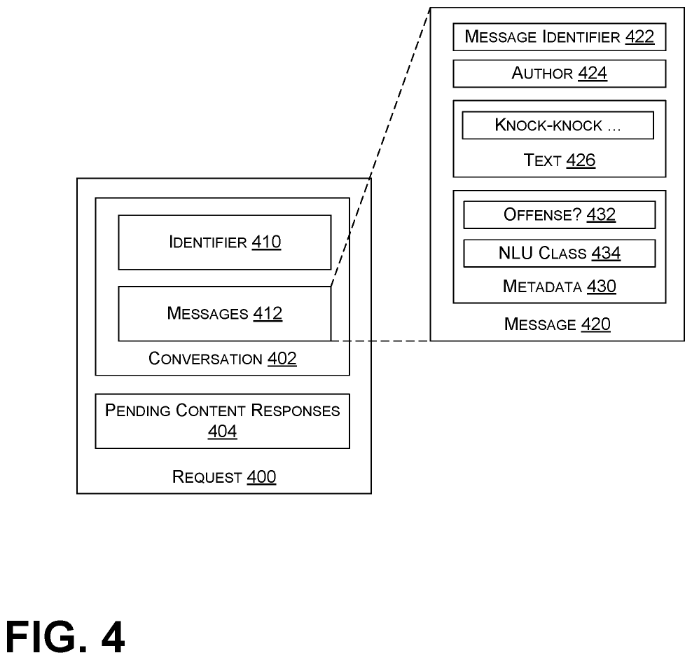

FIG. 4 illustrates a request 400 provided to a chatbot extension 150. Request 400 includes conversation 402 and pending content responses 404. Conversation 402 includes messages 412 and identifier 410. Conversation 402 contains messages for 12 that have already been exchanged between user 120 and chatbot 140. Identifier 410 is a unique identifier used by templates, filters, and other chatbot extensions to refer to a particular conversation. Pending content responses 404 include responses that have been generated by previously executed chatbot extensions 150, but which have not yet been returned to browser 106.

Message 420 is one of messages 412. Message 420 includes message identifier 422, author 424, text 426, and metadata 430. Message identifier 422 is a unique string of letters or characters that can be used to refer to a particular message. Author 424 is a description of the chatbot extension 150 that generated a particular message. Text 426 includes the actual text of the message.

Metadata 430 includes indication 432 that text 426 is offensive and indication 434 of natural language understanding classifications of text 426. For example, offense 432 may be set to true by an extension if it is deemed to contain religiously offensive descriptions. NLU classifications 434 may include entities that were identified in text 426, such as named entities, geographic regions, dates and times, intent, sentiment, and the like.

Subsequent extensions 150 may access metadata 430 and operate accordingly. For example, extension 150B may determine that one of messages 412 generated by extension 150A is offensive. Extension 150B may store this indication in the corresponding metadata 430. Then, extension 150C may attempt to modify the offensive message.

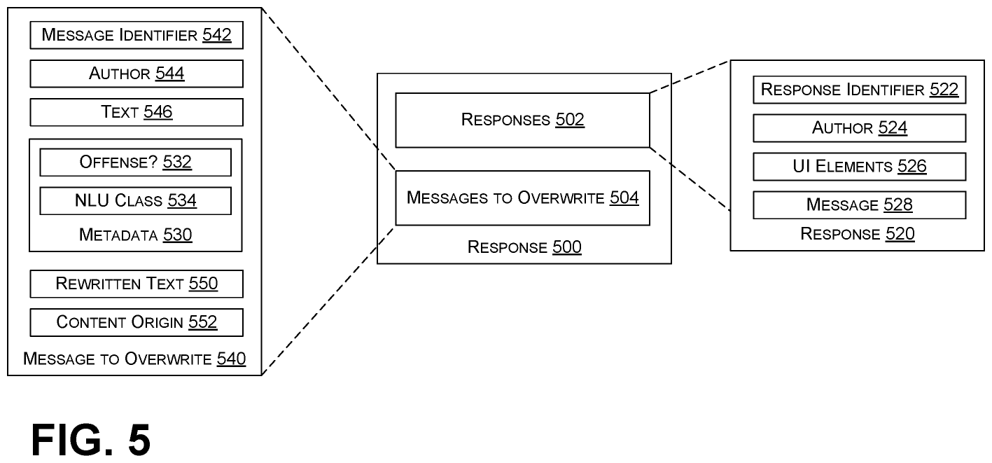

FIG. 5 illustrates a response 500 received from a chatbot extension 150. Response 500 includes response is 502 and messages to overwrite 504. Each response 520 includes a response identifier 522, an author 524, user interface elements 526, and message 528. Response identifier 522 identifies the response 520. Author 524 is a human-readable name of the chatbot extension 150 that generated response 520. UI elements 526 maybe mark-up such as HTML. UI elements 526 may be some intermediate description of a user interface that renders response 520, such as AdaptiveCard. User interface elements 526 may be generated by a template 210 or may be hard coded. Message 528 includes the text of response 520. Message 528 may be provided to chatbot user interface 110 for display.

Message to overwrite 540 of messages to overwrite 504 includes message identifier 542, author 544, text 546, metadata 530, rewritten text 550, and content origin 552. An extension 150 may overwrite some or all of a message, e.g. by removing emojis, correcting grammar, removing forbidden language, etc. Message identifier 542 and author 544 are unique identifiers and names associated with the particular message to overwrite. Text 546 contains the text of the message before it was overwritten. metadata 530 is similar to metadata 430 described above in conjunction with FIG. 4. Metadata 530 of a message may be modified after the message has been generated just as the text of the message may be modified. Rewritten text 550 includes the text that replaces the original text 546. Content origin 552 includes a name of the chatbot extension 150 that modified the text and/or metadata of the existing message.

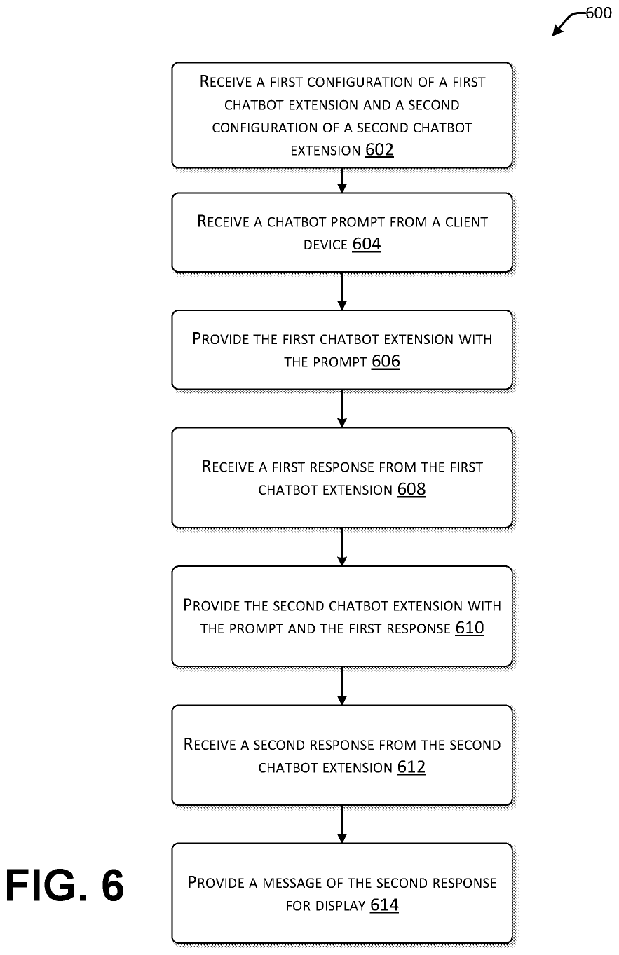

With reference to FIG. 6, routine 600 begins at operation 602, where a first configuration 152A of a first chatbot extension 150A and a second configuration 152B of a second chatbot extension 150B is received. In this way, chatbot 140 is able to invoke an extension 150 by obtaining a URL or other identifier from the corresponding configuration 152.

Next at operation 604, a chatbot prompt 312 is received from client device 104. Chatbot prompt 312 may have originated from a user 102. Chatbot prompts 312 may be simple or complex, and may refer to previously entered prompts 312 or responses 320 that are part of the conversation. For example, chatbot prompt 312 may ask the chatbot 140 to write song, describe bio-electricity, or do a math problem.

Next at operation 606, the first chatbot extension 150A is provided with the prompt 312. In some configurations, filters 216 and other rules described herein are used to determine which extensions 150 to invoke. Rankings and/or dependencies between extensions 150 may be used to determine the order in which they are invoke. These filters 216 and rules may be obtained from the configurations 152 that have been registered with chatbot 140.

Next at operation 608, a first response 320A is received from the first chatbot extension 150A. Some extensions, such as those that chatbot 140 is comprised of, may use a generative linguistic model to create a response 320A to the prompt. Other extensions 150 may sanitize a prompt 312 or a response 320 generated by a previous extension. Other extensions 150 may perform linguistic analysis, add or remove emojis, or any of a number of operations that could be applied as chatbot 140 generates a response 320 to a user-provided prompt 312.

Next at operation 610, the second chatbot extension 150B is provided with the prompt 312 and the first response 320A. In this way, the result of the first extension 150A may be used by the second extension 150B. For example, the first extension 150A may remove offensive language, returning the resulting text in first response 320A. The second chatbot extension 150B may then use first response 320A to synthesize speech, post to a social networking account, or perform some other action on the sanitized result.

Next at operation 612, a second response 320B is received from the second chatbot extension 150B. The second response is commensurate with the operation performed by the second chatbot extension 150B.

Then, at operation 614, a message 528 of the second response 320B is provided to the client 104 for display in the chatbot user interface 110.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 600 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routine 600 may be also implemented in many other ways. For example, the routine 600 may be implemented, at least in part, by a processor of another remote computer or a local circuit. In addition, one or more of the operations of the routine 600 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

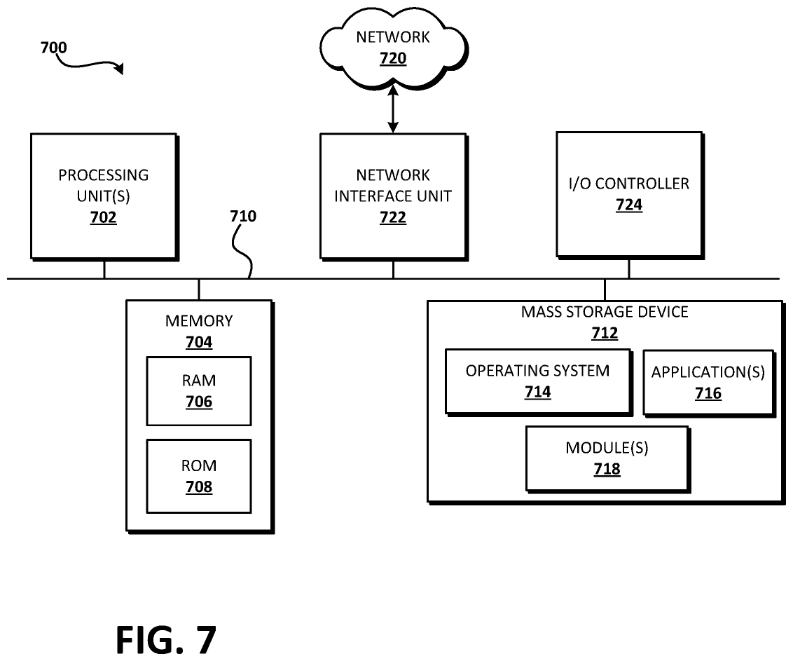

FIG. 7 shows additional details of an example computer architecture 700 for a device, such as a computer or a server configured as part of the systems described herein, capable of executing computer instructions (e.g., a module or a program component described herein). The computer architecture 700 illustrated in FIG. 7 includes processing unit(s) 702, a system memory 704, including a random-access memory 706 (“RAM”) and a read-only memory (“ROM”) 708, and a system bus 710 that couples the memory 704 to the processing unit(s) 702.

Processing unit(s), such as processing unit(s) 702, can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 700, such as during startup, is stored in the ROM 708. The computer architecture 700 further includes a mass storage device 712 for storing an operating system 714, application(s) 716, modules 718, and other data described herein.

The mass storage device 712 is connected to processing unit(s) 702 through a mass storage controller connected to the bus 710. The mass storage device 712 and its associated computer-readable media provide non-volatile storage for the computer architecture 700. Although the description of computer-readable media contained herein refers to a mass storage device, it should be appreciated by those skilled in the art that computer-readable media can be any available computer-readable storage media or communication media that can be accessed by the computer architecture 700.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 700 may operate in a networked environment using logical connections to remote computers through the network 720. The computer architecture 700 may connect to the network 720 through a network interface unit 722 connected to the bus 710. The computer architecture 700 also may include an input/output controller 724 for receiving and processing input from a number of other devices, including a keyboard, mouse, touch, or electronic stylus or pen. Similarly, the input/output controller 724 may provide output to a display screen, a printer, or other type of output device.

It should be appreciated that the software components described herein may, when loaded into the processing unit(s) 702 and executed, transform the processing unit(s) 702 and the overall computer architecture 700 from a general-purpose computing system into a special-purpose computing system customized to facilitate the functionality presented herein. The processing unit(s) 702 may be constructed from any number of transistors or other discrete circuit elements, which may individually or collectively assume any number of states. More specifically, the processing unit(s) 702 may operate as a finite-state machine, in response to executable instructions contained within the software modules disclosed herein. These computer-executable instructions may transform the processing unit(s) 702 by specifying how the processing unit(s) 702 transition between states, thereby transforming the transistors or other discrete hardware elements constituting the processing unit(s) 702.

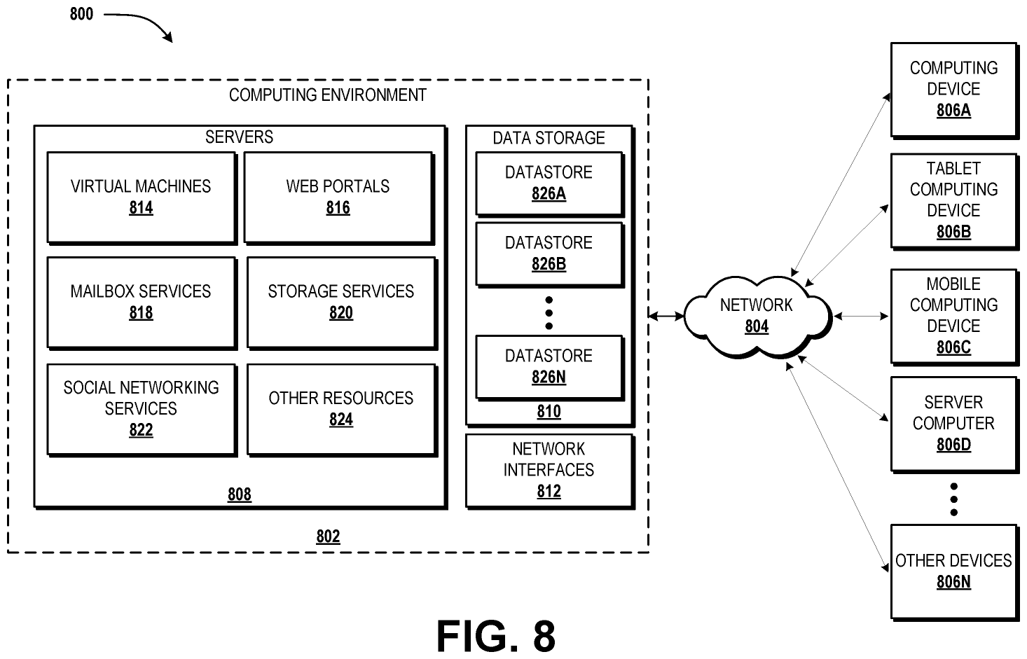

FIG. 8 depicts an illustrative distributed computing environment 800 capable of executing the software components described herein. Thus, the distributed computing environment 800 illustrated in FIG. 8 can be utilized to execute any aspects of the software components presented herein. For example, the distributed computing environment 800 can be utilized to execute aspects of the software components described herein. Accordingly, the distributed computing environment 800 can include a computing environment 802 operating on, in communication with, or as part of the network 804. The network 804 can include various access networks. One or more client devices 806A-806N (hereinafter referred to collectively and/or generically as “clients 806” and also referred to herein as computing devices 806) can communicate with the computing environment 802 via the network 804. In one illustrated configuration, the clients 806 include a computing device 806A such as a laptop computer, a desktop computer, or other computing device; a slate or tablet computing device (“tablet computing device”) 806B; a mobile computing device 806C such as a mobile telephone, a smart phone, or other mobile computing device; a server computer 806D; and/or other devices 806N. It should be understood that any number of clients 806 can communicate with the computing environment 802.

In various examples, the computing environment 802 includes servers 808, data storage 810, and one or more network interfaces 812. The servers 808 can host various services, virtual machines, portals, and/or other resources. In the illustrated configuration, the servers 808 host virtual machines 814, Web portals 816, mailbox services 818, storage services 820, and/or, social networking services 822. As shown in FIG. 8 the servers 808 also can host other services, applications, portals, and/or other resources (“other resources”) 824.

As mentioned above, the computing environment 802 can include the data storage 810. According to various implementations, the functionality of the data storage 810 is provided by one or more databases operating on, or in communication with, the network 804. The functionality of the data storage 810 also can be provided by one or more servers configured to host data for the computing environment 802. The data storage 810 can include, host, or provide one or more real or virtual datastores 826A-826N (hereinafter referred to collectively and/or generically as “datastores 826”). The datastores 826 are configured to host data used or created by the servers 808 and/or other data. That is, the datastores 826 also can host or store web page documents, word documents, presentation documents, data structures, algorithms for execution by a recommendation engine, and/or other data utilized by any application program. Aspects of the datastores 826 may be associated with a service for storing files.

The computing environment 802 can communicate with, or be accessed by, the network interfaces 812. The network interfaces 812 can include various types of network hardware and software for supporting communications between two or more computing devices including, but not limited to, the computing devices and the servers. It should be appreciated that the network interfaces 812 also may be utilized to connect to other types of networks and/or computer systems.

It should be understood that the distributed computing environment 800 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 800 provides the software functionality described herein as a service to the computing devices. It should be understood that the computing devices can include real or virtual machines including, but not limited to, server computers, web servers, personal computers, mobile computing devices, smart phones, and/or other devices. As such, various configurations of the concepts and technologies disclosed herein enable any device configured to access the distributed computing environment 800 to utilize the functionality described herein for providing the techniques disclosed herein, among other aspects.

The present disclosure is supplemented by the following example clauses:

Example 1: A method comprising: receiving a first configuration of a first chatbot extension and a second configuration of a second chatbot extension; receiving a prompt; providing the first chatbot extension with the prompt; receiving a first response from the first chatbot extension; providing the prompt and the first response to the second chatbot extension; receiving a second response from the second chatbot extension, wherein the second response is generated based on the prompt and the first response; and providing a message of the second response for display.

Example 2: The method of Example 1, further comprising: determining to invoke the second chatbot extension based on a filter condition included in the second configuration evaluating to true.

Example 3: The method of Example 1, wherein a metadata property modified by the first chatbot extension is provided to the second chatbot extension.

Example 4: The method of Example 3, wherein the first configuration declares that the first chatbot extension modifies the metadata property.

Example 5: The method of Example 3, wherein the metadata property indicates whether the prompt contains offensive language.

Example 6: The method of Example 1, wherein the second chatbot extension is provided a conversation of messages generated by previous chatbot extensions.

Example 7: The method of Example 6, wherein the second chatbot extension modifies the conversation of messages.

Example 8: A computer-readable storage medium having computer-executable instructions stored thereupon that, when executed by a processing system, cause the processing system to: receive a prompt from a client device; modify the prompt; provide the chatbot with the modified prompt; receive a response from the chatbot; provide the modified prompt and the first response to a chatbot extension, causing the chatbot extension to provide a message to the client device for display.

Example 9: The computer-readable storage medium of Example 8, wherein the chatbot extension emits a log entry based on the response.

Example 10: The computer-readable storage medium of Example 8, wherein the chatbot is implemented with chatbot extensions, and wherein a second chatbot extension extends a one of the chatbot extensions that implement the chatbot.

Example 11: A processing system, comprising: a processor; and a computer-readable storage medium having computer-executable instructions stored thereupon that, when executed by the processor, cause the processing system to: receive a first configuration of a first chatbot extension and a second configuration of a second chatbot extension; receive a prompt from a client device; provide the first chatbot extension with the prompt; receive a first response from the first chatbot extension; provide the prompt and the first response to the second chatbot extension, wherein the first chatbot extension and the second chatbot extension comprise an extension pipeline; receive a second response from the second chatbot extension, wherein the second response is generated based on the prompt and the first response; and provide a message of the second response for display.

Example 12: The processing system of Example 11, wherein the prompt is provided to the extension pipeline and wherein the second response is received from the extension pipeline.

Example 13: The processing system of Example 11, wherein the first configuration declares a preferred location of the first chatbot extension in the pipeline.

Example 14: The processing system of Example 11, wherein a chatbot provides a collection of metadata properties to the extension pipeline, and wherein the second chatbot extension adds or modifies a metadata property to the collection of metadata properties.

Example 15: The processing system of Example 14, wherein the second chatbot extension determines that the first response is accurate based on an analysis of an outside source.

Example 16: The processing system of Example 15, wherein the metadata property indicates that the first response is accurate.

Example 17: The processing system of Example 11, wherein the first configuration registers the first chatbot extension to be invoked by a chatbot when the chatbot is unable to respond to the prompt.

Example 18: The processing system of Example 11, wherein the first chatbot extension adds the first response to a conversation, wherein the second chatbot adds the second response to the conversation, and wherein providing the message of the second response for display comprises providing the conversation for display.

Example 19: The processing system of Example 11, wherein the second configuration declares that the second chatbot extension is to be invoked after the first chatbot extension has been invoked.

Example 20: The processing system of Example 11, wherein the second chatbot extension receives a stream of subsections of the first response as the first response is generated.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
receiving a first configuration of a first chatbot extension and a second configuration of a second chatbot extension;
receiving a prompt;
providing the first chatbot extension with the prompt;
receiving a first response from the first chatbot extension;
providing the prompt and the first response to the second chatbot extension;
receiving a second response from the second chatbot extension, wherein the second response is generated based on the prompt and the first response; and
providing a message of the second response for display.

2. The method of claim 1, further comprising:
determining to invoke the second chatbot extension based on a filter condition included in the second configuration evaluating to true.

3. The method of claim 1, wherein a metadata property modified by the first chatbot extension is provided to the second chatbot extension.

4. The method of claim 3, wherein the first configuration declares that the first chatbot extension modifies the metadata property.

5. The method of claim 3, wherein the metadata property indicates whether the prompt contains offensive language.

6. The method of claim 1, wherein the second chatbot extension is provided a conversation of messages generated by previous chatbot extensions.

7. The method of claim 6, wherein the second chatbot extension modifies the conversation of messages.

8. A computer-readable storage medium having computer-executable instructions stored thereupon that, when executed by a processing system, cause the processing system to:
receive a prompt from a client device;
modify the prompt;
provide the chatbot with the modified prompt;
receive a response from the chatbot;
provide the modified prompt and the first response to a chatbot extension, causing the chatbot extension to provide a message to the client device for display.

9. The computer-readable storage medium of claim 8, wherein the chatbot extension emits a log entry based on the response.

10. The computer-readable storage medium of claim 8, wherein the chatbot is implemented with chatbot extensions, and wherein a second chatbot extension extends a one of the chatbot extensions that implement the chatbot.

11. A processing system, comprising:
a processor; and
a computer-readable storage medium having computer-executable instructions stored thereupon that, when executed by the processor, cause the processing system to:
receive a first configuration of a first chatbot extension and a second configuration of a second chatbot extension;
receive a prompt from a client device;
provide the first chatbot extension with the prompt;
receive a first response from the first chatbot extension;
provide the prompt and the first response to the second chatbot extension, wherein the first chatbot extension and the second chatbot extension comprise an extension pipeline;
receive a second response from the second chatbot extension, wherein the second response is generated based on the prompt and the first response; and
provide a message of the second response for display.

12. The processing system of claim 11, wherein the prompt is provided to the extension pipeline and wherein the second response is received from the extension pipeline.

13. The processing system of claim 11, wherein the first configuration declares a preferred location of the first chatbot extension in the pipeline.

14. The processing system of claim 11, wherein a chatbot provides a collection of metadata properties to the extension pipeline, and wherein the second chatbot extension adds or modifies a metadata property to the collection of metadata properties.

15. The processing system of claim 14, wherein the second chatbot extension determines that the first response is accurate based on an analysis of an outside source.

16. The processing system of claim 15, wherein the metadata property indicates that the first response is accurate.

17. The processing system of claim 11, wherein the first configuration registers the first chatbot extension to be invoked by a chatbot when the chatbot is unable to respond to the prompt.

18. The processing system of claim 11, wherein the first chatbot extension adds the first response to a conversation, wherein the second chatbot adds the second response to the conversation, and wherein providing the message of the second response for display comprises providing the conversation for display.

19. The processing system of claim 11, wherein the second configuration declares that the second chatbot extension is to be invoked after the first chatbot extension has been invoked.

20. The processing system of claim 11, wherein the second chatbot extension receives a stream of subsections of the first response as the first response is generated.
